(19) United States
(12) Patent Application Publication
(10) Pub. No.: US 2004/0159810 A1
(43) Pub. Date: Aug. 19, 2004

(54) Method and apparatus for seat detection and soft seating in a piezoelectric device actuated valve system

(76) Inventors: Christopher F. Gallmeyer, Peoria, IL (US); L. Glenn Waterfield, Peoria, IL (US)

Correspondence Address: CATERPILLAR INC., 100 N.E. ADAMS STREET, PATENT DEPT., PEORIA, IL, 616296490

(21) Appl. No.: 10/774,856

(22) Filed: Feb. 9, 2004

Related U.S. Application Data
(62) Division of application No. 10/163,544, filed on Jun. 6, 2002.

(51) Int. Cl. F16K 31/02

(52) U.S. Cl. 251/129.04

(57) ABSTRACT

A control system for determining and controlling position and velocity of a valve member relative to a valve contact surface in a valve system preferably having an actuator comprised of a piezoelectric device. The control system includes an actuator control circuit for applying a control signal to the actuator to move the member relative to the contact surface. The control system further includes a seat detection circuit for determining when the member impacts the contact surface. The control system further includes a velocity control circuit which utilizes the output of the seat detection circuit from the previous actuation cycle to control the position and velocity of the member relative to the contact surface in the subsequent actuation cycle.

### TECHNICAL FIELD

The present invention relates generally to valves and, more particularly, to an apparatus and method for seat detection and soft seating in a valve having a member actuated by a piezoelectric device.

### BACKGROUND

Piezoelectric materials alter their shape in response to an applied electric field. An electric field applied in the direction of polarization of the material effects an expansion of the material in the same direction, while a voltage applied in the opposite direction of polarization will cause a contraction of the material in that same direction. Piezoelectric benders, which may be pre-stressed thermally, mechanically, or otherwise, such as pre-stressed benders as disclosed in U.S. Pat. Nos. 5,471,721 and 5,632,841, use the “bending” action of piezoelectric material to convert electrical energy into mechanical energy. In such applications, the bender may be used as an actuator. In other applications, an outside force may impart a bending action or mechanical energy to the bender, and the bender then converts that mechanical energy into electrical energy. In such applications, the bender may be used as a sensor.

In electrohydraulic valves having a valve member and contact surface, piezoelectric devices have been used to activate the valve member relative to the contact surface, such as a stop or a seat. In operation, the piezoelectric device deforms in response to a control signal, such as a voltage input signal applied to the piezoelectric device, to move the member either toward or away from the contact surface. Typically, it is desirable to know when the member has reached the contact surface, i.e. seat detection. This is important particularly in proportional valves as the position of the member relative to the contact surface should be determined and controlled to provide the desired flow of fluid through the valve.

Valve seat detection is also desirable in the application of soft-seating techniques. The piezoelectric device must be actuated to move the member a sufficient distance to engage and seal with the contact surface to control the fluid flow, yet, preferably, without severely impacting the member into the contact surface. When the member is moved toward the contact surface with excessive velocity and force, relatively severe impacts may occur, and the contact surface and/or the end of the member may become worn over time. Such impacting of the contact surface may also cause the member to bounce off of the contact surface so that proper control of fluid flow is not achieved. Further, improper control of valve position and valve velocity may reduce the life of the actuator and lead to an undesired loss of control of the fluid flow through the valve.

In the past, valves have incorporated position or load sensors, operating independently of the actuator, to provide soft-seating of the member with the contact surface. Typically, soft-seating utilizes an electronic valve controller to control impact of the valve member with the contact surface by decreasing the velocity of the member as it impacts and engages the contact surface. Position sensors monitor the position of the member relative to the contact surface and provide that information to the controller, which then controls the velocity of the member as it moves toward the contact surface. Load sensors monitor the load applied to the contact surface by the member and provide that information to the controller, which then controls the load, i.e. the force of contact, applied to the contact surface to reduce wear. However, known position and load sensors are relatively large, complex, and/or costly and do not lend themselves well to many electrohydraulic valve applications requiring accurate and reliable valve position and velocity control.

The present invention is directed to overcoming one or more of the problems set forth above.

### SUMMARY OF THE INVENTION

In a first embodiment, an apparatus for determining position of a valve member relative to a valve contact surface is disclosed. The member is operatively connected to an actuator. The apparatus comprises an actuator control circuit operatively connected to the actuator and operable to apply a control signal to the actuator to move the member relative to the contact surface and operable to produce an output from the actuator and a seat detection circuit operatively connected to the actuator control circuit and operable to determine contact of the member with the contact surface from the output, wherein the actuator is a piezoelectric device.

In a second embodiment, an apparatus for controlling velocity of a valve member relative to a valve contact surface is disclosed. The member is operatively connected to an actuator. The apparatus comprises an actuator control circuit operatively connected to the actuator and operable to apply a control signal to the actuator to move the member relative to the contact surface and operable to produce an output from the actuator; a seat detection circuit operatively connected to the actuator control circuit and operable to determine contact of the member with the contact surface from the output; and a velocity control circuit operatively coupled to the actuator control circuit and operable to send an input to the actuator control circuit, the actuator control circuit controlling the velocity of the member from the input, wherein the actuator is a piezoelectric device.

In a third embodiment, a valve is disclosed. The valve comprises an actuator comprised of a piezoelectric device having one or more prestressed electroactive benders; a member operatively connected to the actuator; a contact surface, the member operable to move relative to the contact surface and to contact the contact surface; and a control system operatively connected to the actuator for determining a position of the member relative to the contact surface.

In a fourth embodiment, a valve is disclosed. The valve comprises an actuator comprised of a piezoelectric device having one or more prestressed electroactive benders; a member operatively connected to the actuator; a contact surface, the member operable to move relative to the contact surface and to contact the contact surface; and a control system operatively connected to the actuator for controlling the velocity of the member relative to the contact surface.

In a fifth embodiment a method of determining position of a valve member relative to a valve contact surface, wherein the member is operatively connected to an actuator, is disclosed. The method comprises applying a control signal to the actuator to cause the member to move relative to the contact surface; determining an output of the actuator; and determining contact of the member with the contact surface from the output.

### BRIEF DESCRIPTION OF THE DRAWINGS

FIG. 1 is a diagrammatic view of an exemplary piezoelectric device actuated valve, including a control system in accordance with the principles of the present invention;

FIG. 2 is a block diagram of the control system shown in FIG. 1 providing seat detection in accordance with a first embodiment of the present invention;

FIGS. 3(a) and 3(b) are graphs illustrating output voltage of the piezoelectric device versus time for free and blocked motion, respectively, of the piezoelectric device in accordance with principles of the present invention; and

FIG. 4 is a block diagram of the control system shown in FIG. 1 providing soft seating in accordance with a second embodiment of the present invention.

### DETAILED DESCRIPTION

The following is a detailed description of the best mode embodiment of the present invention, with sufficient detail to permit someone skilled in the art to make and use the claimed invention. The present invention, however, is not limited to the embodiment disclosed and described herein. To the contrary, the present invention may include all those alternative embodiments and equivalents that fall within the scope of the present invention as defined by the appended claims.

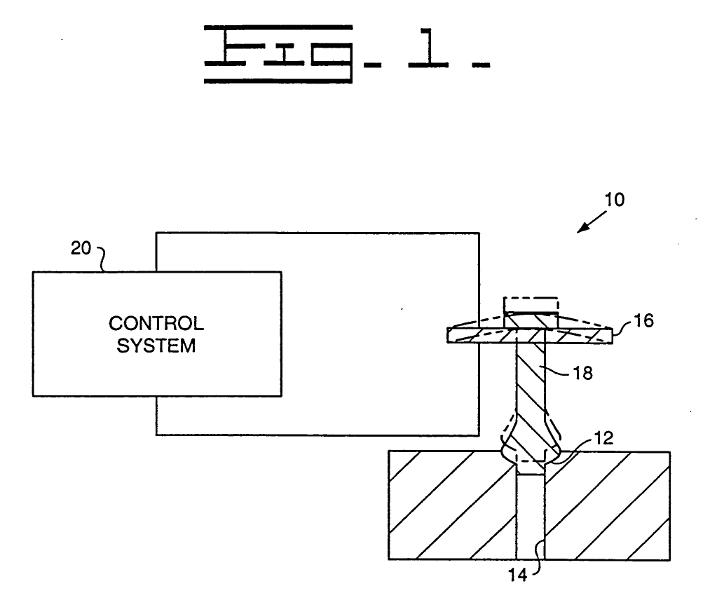

FIG. 1 illustrates an electrohydraulic valve 10 consistent with an exemplary embodiment of the present invention. The valve 10 is illustrated as a blocking valve, but it could be any type known in the art, including, for example, a ball valve, a spool valve, or a poppet valve. In addition, the valve 10 could be a two-way valve or multi-way valve without departing from the present invention. The valve 10 includes at least one contact surface 12. The contact surface 12 may be comprised of a seat formed at one end of a fluid passage 14; alternatively the contact surface 12 may be comprised of a stop. The valve 10 further includes an actuator 16, which is preferably a piezoelectric device, a valve member 18 connected to actuator 16, and an actuator control system 20 coupled to the actuator 16 for moving the member 18 relative to the contact surface 12.

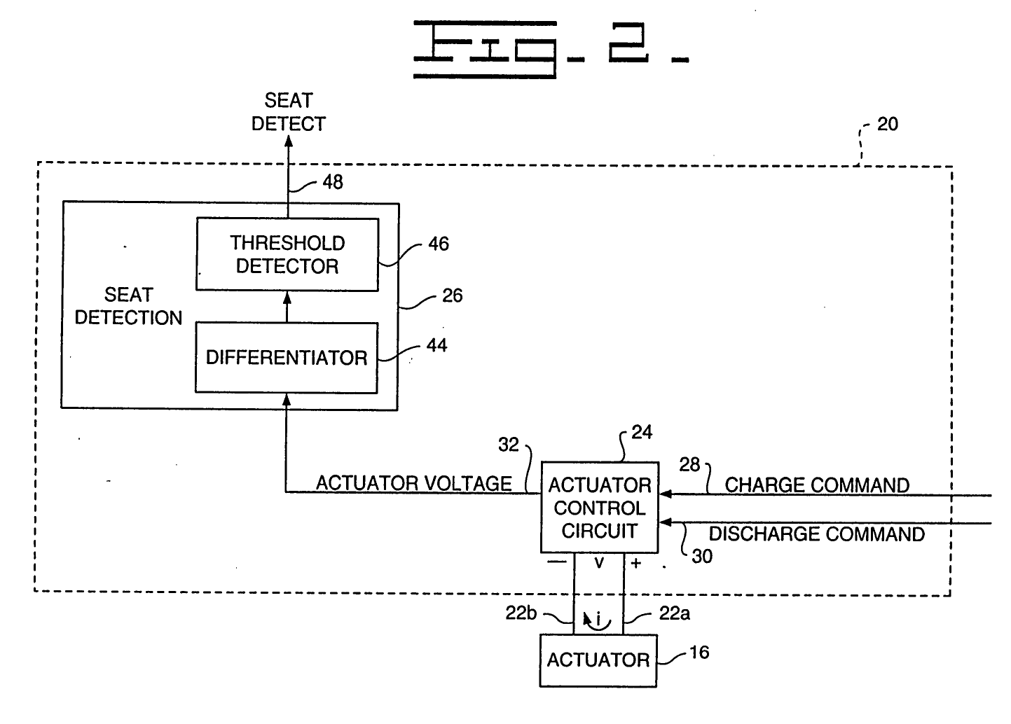

The piezoelectric device utilized as actuator 16 preferably is comprised of one or more pre-stressed electroactive benders, which may be pre-stressed thermally, mechanically, or by other means, that change shape by deforming in opposite axial directions in response to a control signal supplied by the control system 20. Individual benders may be stacked or bonded together into a single, multi-layered element. The control signal may be a voltage signal supplied from the control system 20 to the actuator 16 through a pair of electrical leads 22a and 22b (as seen in FIG. 2). Alternatively, the actuator 16 may be controlled by a current signal supplied by the control system 20.

The piezoelectric device may be circular, rectangular, square or any other regular or irregular shape, although a circular shape is preferred, and includes at least one electroactive layer (not shown) positioned between a pair of electrodes (not shown) or other means for supplying a voltage to the electroactive layer. Other configurations are possible as well without departing from the spirit and scope of the present invention. In a de-energized or static state, the piezoelectric device is preferably pre-stressed to have a domed configuration as shown in phantom in FIG. 1. When the electrodes are energized to place the piezoelectric device in an actuated state, such as when a voltage or current control signal is applied by the control system 20, the piezoelectric device displaces axially from its static state by flattening or doming further depending on the polarity of the applied charge.

As shown in FIG. 1, the member 18 is preferably positioned away from the contact surface 12 when the piezoelectric device, or actuator 16, is in the domed configuration. As the actuator 16 flattens in response to the control signal applied by the control system 20, the member 18 is moved toward and into contact with the contact surface 12 to seal the fluid passage 14.

As seen in FIG. 2, control system 20 may detect the seating of the member 18, i.e. the contacting of the member 18 with the contact surface 12.

Control system 20 preferably includes an actuator control circuit 24 and a seat detection circuit 26. The actuator control circuit 24 is preferably connected to the actuator 16 via the electrical leads 22a and 22b by which the actuator control circuit 24 applies a current or voltage signal to the actuator 16 to control the movement of the piezoelectric device. The actuator control circuit 24 receives a charge command on connector 28 and a discharge command on connector 30, as determined by the control system 20, by which the circuit 24 determines the current signal to apply to the actuator 16. The actuator control circuit 24 outputs an actuator voltage on connector 32 indicative of the actual real-time voltage generated by the actuator 16.

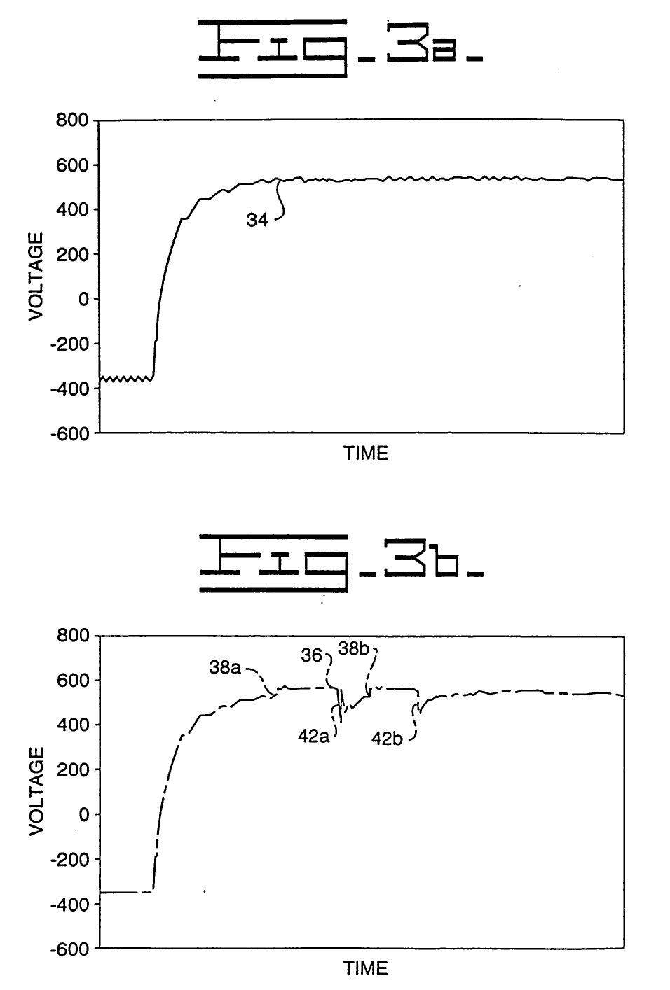

The graphs illustrated in FIGS. 3(a) and 3(b) illustrate the actuator voltage output on connector 32 from the actuator control circuit 24. FIG. 3(a) illustrates a voltage trace 34 representing free motion of the piezoelectric device, i.e. when the actuator 16 is charged to reach a position in the free space. The actuator 16 acts as a spring/mass system, overshoots its position, and oscillates for a period of time. As the actuator 16 oscillates and changes shape, the voltage in and out of the piezoelectric device also oscillates until the actuator reaches a steady state. FIG. 3(b) illustrates a voltage trace 36 representing blocked motion of the piezoelectric device, i.e. when the member 18 impacts the contact surface 12. When the impact occurs, the amplitude of the actuator voltage abruptly changes as represented by the spikes in amplitude at 38a and 38b. As the member 18 rebounds from the contact surface 12 and bounces, the amplitude of the voltage abruptly changes again as seen at 42a and 42b, and the oscillations eventually cease as the actuator 16 reaches steady state in contact with the contact surface 12.

The seat detection circuit 26 receives the actuator voltage on connector 32, i.e. the voltage trace 34 or 36 as seen in FIG. 3, and outputs a seat detection on connector 48 indicating the member 18 has impacted the contact surface 12. The seat detection circuit 26 preferably includes a differentiator 44 and a threshold detector 46.

The differentiator 44, which is known by those of ordinary skill in the art, is operable to measure the instantaneous rate of change of the actuator voltage received on connector 32. Alternatively, the differentiator 44 may measure a rate of change in the frequency domain or any other characteristic in the actuator voltage 32 that represents impact of the member 18 with the contact surface 12. The threshold detector 46, which is known by those of ordinary skill in the art, receives the rate of change from the differentiator 44 and evaluates the signal for the abrupt change 38a or 38b indicative of initial impact of the member 18 with the contact surface 12. Preferably, the threshold detector 46 filters the signal received from the differentiator 44 and compares the filtered signal to a predetermined value, the predetermined value being a change in voltage amplitude indicative of impact. When the rate of change received from the differentiator 44 is sufficiently large and exceeds the predetermined value, impact of the member 18 and the contact surface 12 is determined to have occurred. The seat detection circuit 26 then outputs the seat detection on connector 48 indicative of the actuator voltage at which member 18 and contact surface 12 impacted. Of course, it will be appreciated that other output characteristics of the actuator 16, such as current or charge, may be evaluated to detect impact of the member 18 with the contact surface 12 without departing from the spirit and scope of the present invention.

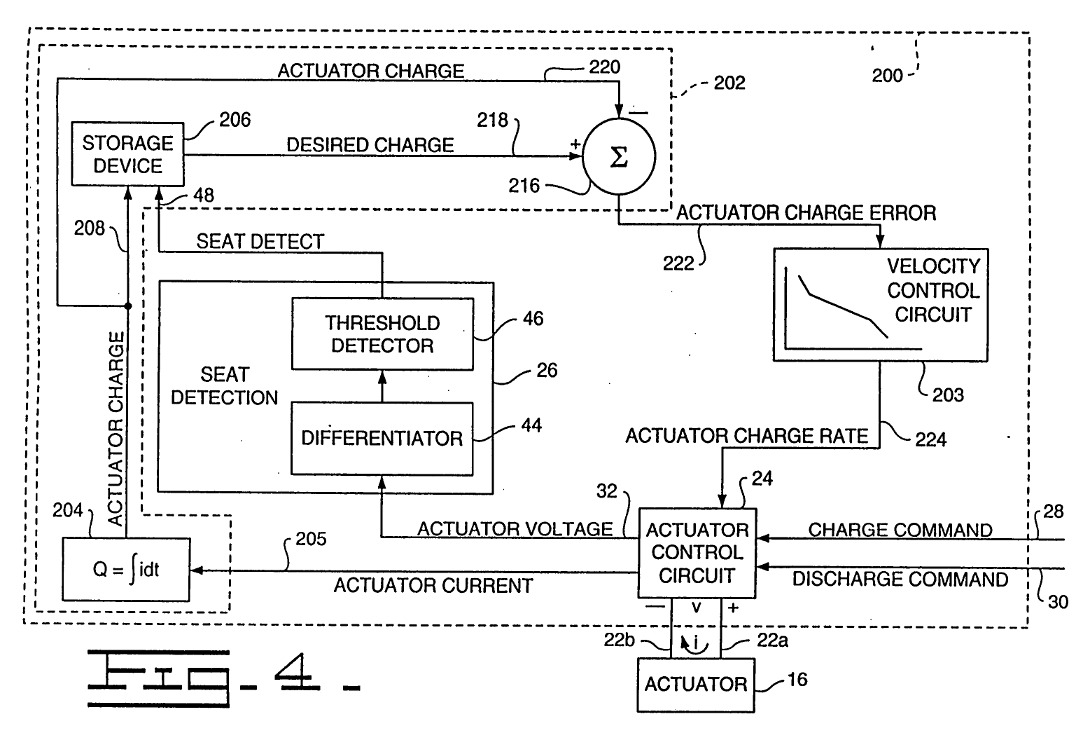

Referring now to FIG. 4, a second embodiment of the control system, identified as control system 200, is shown, where like numerals represent like parts to the control system 20 of FIG. 2. In this embodiment, the control system 200 provides for both seat detection and soft-seating of the member 18. The control system 200 utilizes the actuator charge determined in the previous actuation cycle to control the velocity, or charge, of the actuator 16 in the current cycle.

The control system 200 includes a position control circuit 202 connected to the actuator control circuit 24 and to the valve seat detection circuit 26 for determining the position of the member 18 relative to the contact surface 12. The control system 200 further includes a velocity control circuit 203 connected to the position control circuit 202 and to the actuator control circuit 24. The position control circuit 202 includes a current integrator 204 that is operable to receive and integrate the actuator current on connector 205, which is indicative of the current flowing through the actuator 16 or piezoelectric device, to determine a charge existing on the piezoelectric device and output an actuator charge on connector 208. The position control circuit 202 further includes a memory or other storage device 206 which receives the actuator charge on connector 208 from the current integrator 204 and stores a value representing the charge existing on the piezoelectric device 16 when the member 18 impacted the contact surface 12.

Further, the seat detection circuit 26, as described in conjunction with FIG. 2, is operable to output a seat detect on connector 48, which is received by the storage device 206. In response to receiving the seat detect on connector 48 output by the seat detection circuit 26, the storage device 206 stores the concurrent actuator charge from connector 208, i.e. the value representing the charge existing on the piezoelectric device 16 when the seat detection occurred. Thus, the charge existing on the piezoelectric device when the position of the member 18 is known is stored so that the charge can be used in the next actuation cycle to determine the position of the member 18.

The position control circuit 202 further includes a comparator 216 that is operable to receive from the storage device 206 a desired charge on connector 218 which is equivalent to the charge stored during the previous cycle and corresponds to the desired position of the member 18, i.e. at which the member 18 and contact surface 12 are in contact. The comparator 216 is further operable to receive the actuator charge on connector 220, i.e. the charge existing on the piezoelectric device 16 during the current cycle. The comparator 216 is operable to compare the desired charge from connector 218 with the actuator charge from connector 220. The comparator 216 outputs an actuator charge error on connector 222 representing the difference between the desired charge on the piezoelectric device, i.e. the position of the member 18 at which it last contacted the contact surface 12, and the actual charge on the piezoelectric device, i.e. the current position of member 18. Thus the actuator charge error, which is received by the velocity control circuit 203, represents the current position of the member 18 relative to the contact surface 12.

The velocity control circuit 203 preferably is a one-dimensional map, such as a look-up table, polynomial or other function, and utilizes the actuator charge error to determine the appropriate velocity of the member 18 based upon the relative position of member 18. The circuit 203 outputs an actuator charge rate on connector 224 to the actuator control circuit 24 to control the rate of charge of the piezoelectric device and thus the velocity of it and member 18. The velocity control circuit 203 includes a predetermined velocity profile relating the actuator charge error, or relative current position of the member 18, to the desired velocity of the member 18. The velocity control circuit 203 determines the desired velocity and outputs an actuator charge rate on connector 224. As the velocity of the member 18 is proportional to the rate of charge on the piezoelectric device, the actuator charge rate may be used by the actuator control circuit 24 to slow the rate of charge on the piezoelectric device as the member 18 approaches the contact surface 12, thus lessening the force of impact.

In operation of the control system 200 of FIG. 4, the actuator control circuit 24 receives the charge command on connector 26. In response to the charge command, the actuator control circuit 24 continuously charges the piezoelectric device to move the member 18 relative to the contact surface 12. In one embodiment, the actuator control circuit 24 moves the member 18 towards the contact surface 12 in response to the charge command. During a first actuation cycle the output voltage, or the actuator voltage on connector 32, of the piezoelectric device is supplied to the seat detection circuit 26. The member 18 moves continuously toward the contact surface 12 until the seat detection circuit 26 detects impact of the member 18 with the contact surface 12 by detecting an abrupt change in the amplitude of the output voltage, such as 38a and 38b as seen in FIG. 3. Upon determining that the abrupt change is sufficiently large so as to indicate an impact between the member 18 and the contact surface 12, the seat detection circuit 26 also outputs the seat detect on connector 48 to the storage device 206, which causes the storage device 206 to store the actuator charge from connector 208, i.e. the value representing the charge existing on the piezoelectric device 16 when the member 18 impacts the contact surface 12. The storage of this charge 208 ends the first valve actuation cycle.

During a second valve actuation cycle, the charge stored in storage device 206 from the previous cycle is output to the comparator 216 as the desired charge on connector 218. The comparator 216 compares this signal to the actuator charge on connector 220 representing the actual charge on the actuator 16 during the current cycle. The comparator 216 outputs the difference of the desired and actuator charges to the velocity control circuit 203 as the actuator charge error on connector 222. From the map comprising the velocity control circuit 203, an actuator charge rate corresponding to the determined actuator charge error is determined and output on connector 224 to the actuator control circuit 24. The actuator charge rate is utilized by the actuator control circuit 24 to control the rate of charge on the piezoelectric device and, thus, the velocity of member 18. Therefore, the velocity of member 18 may be adjusted to slow the member 18 as it approaches and impacts the contact surface 12 and, thus, allow for soft-seating of the member 18. When the member 18 contacts the contact surface 12, seat detection circuit 26 sends a seat detect on connector 48, a new actuator charge is stored in storage device 206, and the cycle begins again.

### Industrial Applicability

In use, it will be appreciated that control system 20 or 200 is operable to move the member 18 into contact with the contact surface 12 in response to the charge command 26. The control system 20 is further operable to determine when valve member 18 impacts the contact surface 12. The control system 200 is further operable to determine the position of the member 18 relative to the contact surface 12. The comparator 216 of the position control circuit 202 compares the desired charge determined from the previous actuation cycle with the current charge on the piezoelectric device and provides the difference to the velocity control circuit 203 as the actuator charge error. The velocity control circuit 203 is operable to determine the appropriate actuator charge rate from the actuator charge error and output that rate to the actuator control circuit 24. This circuit 24 then controls the rate of charge of the piezoelectric device. Since the velocity of the member 18 is proportional to the rate of charge on the piezoelectric device, more accurate and reliable control of the velocity of member 18 may be obtained through the position control circuit 202 and velocity control circuit 203 of control system 200.

What is claimed is:

1. A valve, comprising:
an actuator comprised of a piezoelectric device comprising one or more prestressed electroactive benders;
a member operatively connected to the actuator;
a contact surface, wherein the member is operable to move relative to the contact surface and to contact the contact surface; and
a control system operatively connected to the actuator for determining a position of the member relative to the contact surface.

2. The valve, as set forth in claim 1, wherein the control system comprises:
an actuator control circuit operatively connected to the actuator and operable to apply a control signal to the actuator, the control signal controlling movement of the member relative to the contact surface, and operable to receive an output from the actuator; and
a seat detection circuit operatively connected to the actuator control circuit and operable to determine contact of the member with the contact surface from the output.

3. The valve, as set forth in claim 2, wherein the output comprises a voltage produced by the actuator.

4. The valve, as set forth in claim 3, wherein the seat detection circuit determines a rate of change of the output.

5. The valve, as set forth in claim 4, wherein the seat detection circuit determines contact of the member with the contact surface from a comparison of the rate of change of the output to a predetermined value.

6. A valve, comprising:
an actuator comprised of a piezoelectric device comprising one or more prestressed electroactive benders;
a member operatively connected to the actuator;
a contact surface, wherein the member is operable to move relative to the contact surface and to contact the contact surface; and
a control system operatively connected to the actuator for controlling the velocity of the member relative to the contact surface.

7. The valve, as set forth in claim 6, wherein the control system comprises:
an actuator control circuit operatively connected to the actuator and operable to apply a control signal to the actuator, the control signal controlling movement of the member relative to the contact surface, and operable to receive an output from the actuator;
a seat detection circuit operatively connected to the actuator control circuit and operable to determine contact of the member with the contact surface from the output; and
a velocity control circuit operatively coupled to the actuator control circuit and to the seat detection circuit and operable to provide an input to the actuator control circuit for controlling the velocity of the member.

8. The valve, as set forth in claim 7, further comprising:
a position control circuit operatively connected to the actuator control circuit, the seat detection circuit, and the velocity control circuit, the position control circuit having a stored charge value and a current charge value.

9. The valve, as set forth in claim 8, wherein the position control circuit determines a charge error as a function of the stored charge value and the current charge value.

10. The valve, as set forth in claim 9, wherein the velocity control circuit determines the input as a function of the charge error.

11. The valve, as set forth in claim 8, wherein the position control circuit includes an integrator operable to integrate current flowing through the actuator during a current actuation cycle to determine the current charge value.

12. The valve, as set forth in claim 11, wherein the stored charge value is determined by the seat detection circuit during a prior actuation cycle.

13. An apparatus for determining position of a valve member relative to a valve contact surface, wherein the member is operatively connected to an actuator, comprising:
an actuator control circuit operatively connected to the actuator and operable to apply a control signal to the actuator, the control signal controlling movement of the member relative to the contact surface, and operable to receive an output from the actuator; and
a seat detection circuit operatively connected to the actuator control circuit and operable to determine contact of the member with the contact surface from the output;
wherein the actuator is a piezoelectric device.

14. The apparatus, as set forth in claim 13, wherein the output comprises a voltage produced by the actuator.

15. The apparatus, as set forth in claim 14, wherein the seat detection circuit determines a rate of change of the output.

16. The apparatus, as set forth in claim 15, wherein the seat detection circuit determines contact of the member with the contact surface from a comparison of the rate of change of the output to a predetermined value.

17. An apparatus for controlling velocity of a valve member relative to a valve contact surface, wherein the member is operatively connected to an actuator, comprising:
an actuator control circuit operatively connected to the actuator and operable to apply a control signal to the actuator, the control signal controlling movement of the member relative to the contact surface, and operable to receive an output from the actuator;
a seat detection circuit operatively connected to the actuator control circuit and operable to determine contact of the member with the contact surface from the output; and
a velocity control circuit operatively coupled to the actuator control circuit and seat detection circuit and operable to provide an input to the actuator control circuit for controlling velocity of the member;
wherein the actuator is a piezoelectric device.

18. The apparatus, as set forth in claim 17, further comprising:
a position control circuit operatively connected to the actuator control circuit, the seat detection circuit, and the velocity control circuit, the position control circuit having a stored charge value and a current charge value.

19. The apparatus, as set forth in claim 18, wherein the position control circuit determines a charge error as a function of the stored charge value and the current charge value.

20. The apparatus, as set forth in claim 19, wherein the velocity control circuit determines the input as a function of the charge error.

21. The apparatus, as set forth in claim 18, wherein the position control circuit includes an integrator operable to integrate current flowing through the actuator during a current actuation cycle to determine the current charge value.

22. The apparatus, as set forth in claim 21, wherein the stored charge value is determined by the seat detection circuit during a prior actuation circuit..

23. A method of determining position of a valve member relative to a valve contact surface, wherein the member is operatively connected to an actuator comprised of a prestressed electroactive bender, comprising:
applying a control signal to the actuator to cause the member to move relative to the contact surface;
determining an output of the actuator; and
determining contact of the member with the contact surface from the output.

24. The method, as set forth in claim 23, further comprising:
comparing the output to a predetermined value to determine contact of the member with the contact surface.

25. A method of controlling velocity of a valve member relative to a valve contact surface, wherein the member is operatively connected to an actuator comprised of a prestressed electroactive bender, comprising:
storing an output of the actuator in a prior actuation cycle;
determining an output of the actuator in a current actuation cycle; and
modifying the velocity of the member as a function of the stored and current outputs.

26. The method, as set forth in claim 25, wherein the modifying step further comprises:
comparing the current output and the stored output to generate a control signal representing a desired change in charge on the actuator; and
applying the control signal to the actuator to control the velocity of the member,
wherein the stored output indicates a seated position of the member during the prior actuation cycle.
